(19) United States
(12) Patent Application Publication
(10) Pub. No.: US 2014/0199906 A1
(43) Pub. Date: Jul. 17, 2014

(54) CYANATE-BASED RESINS WITH REDUCED VISCOSITY AND DUROMERS PRODUCED THEREFROM WITH IMPROVED IMPACT RESISTANCE

(71) Applicants: Monika Bauer, Koenigs-Wusterhausen (DE); Christoph Uhlig, Berlin (DE)

(72) Inventors: Monika Bauer, Koenigs-Wusterhausen (DE); Christoph Uhlig, Berlin (DE)

(73) Assignee: Fraunhofer-Gesellschaft zur Foerderung der angewandten Forschung e.V., Muenchen (DE)

(21) Appl. No.: 14/119,624

(22) PCT Filed: May 29, 2012
(86) PCT No.: PCT/EP2012/060046

§ 371 Date: Mar. 12, 2014

(30) Foreign Application Priority Data
May 27, 2011 (DE) 102011050675.6

(51) Int. Cl. C08L 83/14; D06M 15/37; C09D 183/14

(52) U.S. Cl. CPC C08L 83/14; C09D 183/14; D06M 15/37
USPC 442/147; 525/452; 524/588

(57) ABSTRACT

The invention relates to a cyanate resin that can be obtained by mixing at least
(i) one difunctional, oligofunctional and/or polyfunctional cyanate and/or of at least one prepolymer thereof, optionally in combination with at least one additional copolymerizable component and
(ii) at least one siloxane and/or a siloxane-containing compound, characterized in that said resin contains a linear polydialkylsiloxane with a viscosity ranging from 500 to 1500 and/or a polydialkylsiloxane caprolactone or caprolactam copolymer as siloxane and/or siloxane-containing compound.

The invention further relates to a substrate that is saturated or coated with said type of cyanate resin, and a duromer that can be obtained by compressing and/or heating the cyanate resin or the saturated or coated substrate.

The invention concerns prepolymers, in particular resins and/or cyanate resins containing at least one cyanate and/or at least one prepolymer thereof, and at least one siloxane-curing agent dispersed therein.

Amongst other uses, cyanate resins are used as impregnating agents for textiles and sandwich structures (in particular honeycomb structures) or textiles that, for example, are used by the aviation industry. Materials thus impregnated have strengths and comparatively low flammability suitable for this application.

To ensure good processing of the resins, they may contain additional rheological modifiers. Said modifiers or other fillers may also be desirable for improving adhesion, hardness, toughness, impact resistance, hydrophilicity/hydrophobicity, or the like. These modifiers within cyanate resins may not adversely affect the excellent fire properties of cyanate resins (low heat release rate, minimal smoke density, a low proportion of toxic gases in a fire situation). In particular, the fluid flow properties of the resins can optionally be adjusted by modifiers in a manner that produces excellent surfaces of products by heat curing (e.g., in a press).

Known resins demonstrate low thermal resistance due to use of cyanate resins containing rubber compounds, whereby the rubber compounds are used to increase impact strength.

The object of the present invention is to provide resins and/or cyanate resins, which have a relatively low viscosity prior to curing, thereby making them particularly suitable for the application with procedures such as infusion and pultrusion, while having improved impact strength and/or fracture strength and/or fracture toughness after curing, and thereby favorably support the thermal form stability of duromers made thereof.

This object is solved by the subject matter of the main claim, whereby the dependent claims and independent claims relate to preferred embodiments of the invention. Features of different embodiments may be combined among one another.

For this purpose, there is provided a resin or cyanate resin, that is obtained by mixture of at least one (i.e., one or more), preferably difunctional, oligofunctional and/or polyfunctional cyanate and at least one (i.e., one or more), siloxane and/or at least one siloxane-containing component. Alternatively, or in addition to said cyanate, at least one (i.e., one or more) prepolymer can be mixed with said siloxane to obtain the cyanate resin of the present invention. This prepolymer is also referred to as precursor prepolymer hereinafter.

Optionally, said cyanate and/or precursor polymer may be combined with at least one additional co-polymerizable component, which is advantageously consists of or contains one monomeric, oligomeric or polymeric silazane.

In the context of the present invention, “prepolymer”, “resin”, and “prepolymerized resin” are to be understood respectively to mean an addition polymer that is cross-linked below the gel point and made from or by using the aforementioned starting materials.

The ratio of the siloxane and/or the siloxane component should be 0.5 to 50 percent by weight relative to the total weight of the cyanate resin of the present invention. Preferable is 2 to 15 percent by weight. The siloxane and/or siloxane compound is dispersed advantageously in accordance with one embodiment. It has a preferable viscosity between 0.65 to 2,000,000, preferably between 10 to 100,000, more preferably between 100 to 10,000 mPas.

Of preference are siloxane and/or siloxane-containing components wherein said cyanate resin is homogeneously finely distributed as polyorganosiloxane droplets having a diameter of preferably between 0.001 to 4 micrometer, preferably between 0.01 to 0.8 micrometer, most preferably between 0.02 to 0.4 micrometers.

Specifically, a siloxane of the type organopolysiloxane is a polymer of the general formula (R3SiO1/2)w(R2SiO2/2)x. (RSiO3/2)y. (SiO4/2)z, wherein w=0 to 20 percent mol, x=80 to 99.59 percent mol, y=0.5 to 10 percent mol, z=0 to 10 percent mol, wherein R is preferably an alk(en)yl, aryl or alkoxy moiety, preferably methyl or ethyl, or—in particular at the termini—is a methoxy or ethoxy, or a mixture of said polymers. From the formula it follows that these polyorganosiloxanes have a linear structure without reactive terminal groups such as hydroxy groups. Terminal trialkylsilyl groups are preferred, particularly terminal trimethylsilyl groups. The average molecular weight of the siloxane is preferably relatively low, to thereby achieve the desired properties. A viscosity in the advantageous range between 50 and 10,000 mPas, in particular between 150-1500 mPas.

In a preferred embodiment, the cyanate resin contains a polydialkylsiloxane-caprolactone-copolymer or a polydialkylsiloxane-caprolactam-copolymer, in particular polydimethylsiloxane-caprolactone copolymer or polydimethylsiloxane-caprolactam copolymer. Of particular advantage is the at least one siloxane being a polydialkylsiloxane-caprolactone copolymer or said siloxane being contained therein. In other words: polydialkylsiloxane-caprolactone copolymers and/or caprolactam-copolymers may be employed as sole siloxane-containing components or in admixture with other siloxane-containing components or with at least one siloxane. The polydimethyl-siloxane-caprolactone copolymer is present for example in form of a wax, can also, according to the present invention, be employed in any other state of aggregation, preferably in form of a linear block-copolymer either of the composition AₓB with x or, preferably, of composition ABA. The silicone component B therein is of variable length and located in the middle portion of the block, flanked by caprolactone groups and/or caprolactam groups and/or reaction products thereof. Preferably, the terminal caprolactone or caprolactam moieties are capped, precluding copolymer reactive terminal groups, but rather alkyl, alkoxy or aryl groups. The alkyl groups of the silicone component should also be free of reactive substituents in particular. In order to achieve the desired properties, the average molecular weight of the copolymer is preferably relatively low. Suitable are ranges between 500 g/mol and 4000 g/mol, preferred ranges are between 600 and 3500 g/mol, more preferred are ranges between 800 and 3000 g/mol, yet more preferred are ranges between 800 and 2500, and most preferred are ranges between 900 and 2000. The proportion of copolymer contained in the resin may vary; in general between 2 to 10 percent weigh relative to the cyanate resin are advantageous. Of preference are proportions of 3.5 to 6.5 percent weight.

Most preferably, a linear polydialkylsiloxane-caprolactone copolymer or caprolactam-block copoylmer are employed as sole siloxane-containing component, in particular having the aforementioned molecular weights. Particularly preferred in this embodiment is the absence of additional polydialkylsiloxanes. The use of a polydialkylsiloxane-caprolactone copolymer, in particular a polydimethylsiloxane-caprolactone copolymer is further particularly preferred.

In an additional preferred embodiment, a linear polydialkylsiloxane is employed, preferably in admixture with aforementioned caprolactone copolymer and/or caprolactam polymer. The weight ratio of the two components is preferably between 10 parts polydialkylsiloxane to 1 part caprolactone copolymer and/or caprolactam copolymer, and in a ratio of 1:1.

Alternatively or in addition, a silicone oil formulation as siloxane-containing compound may be advantageously employed. Particularly preferable is polyorganosiloxane with aforementioned properties, in particular with a viscosity in the range between 800 to 1200.

The use of exclusively linear, non-cross-linked siloxanes and/or siloxane-containing components enables the manufacture of resins with relatively low viscosity, in particular below 100 mPas, therefore being particularly well suited for applications that require use of a liquid or pasty materials.

The choice of the multi-functional cyanate to be used as a starting material for the resin is not critical. Principally, any at least bi-functional cyanate molecule can be used, most notably aromatic cyanates and, amongst these particularly bi-or poly-functional cyanates of the structural formulas I-III:

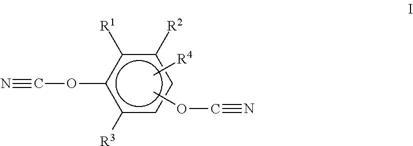

wherein R¹ to R⁴ are hydrogens, respectively, C₁-C₁₀-alkyl, C₃-C₈-cycloalkyl, C₁-C₁₀ alkoxy, halogen (F, CI, Br or I), phenyl or phenoxy, whereby the alkyl or aryl groups may be fluorinated or partially fluorinated. Examples are phenylene-1,3-dicyanate, phenylene-1,4-dicyanate, 2,4,5-trifluorophenylen-1,3-dicyanate;

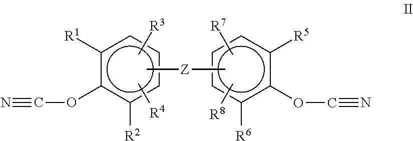

wherein R⁵ to R⁵ are identical with R¹ to R⁴ and Z is a chemical bond, SO₂, CF₂, CH₂, CHF, CH(CH₃), isopropylene, hexafluoroisopropylen, C₁-C₁₀ alkylene, O, NR⁹, N═N, CH═CH, COO, CH═N, CH═N—N═CH, alkyleneoxyalkylene with C₁-C₈ alkylene, S, Si (CH₃)₂ or

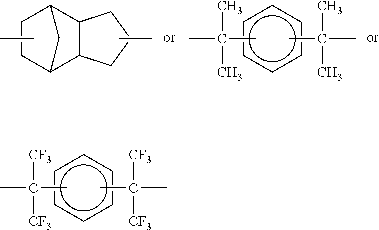

Examples are 2,2-bis(4-cyanato-phenyl)propane, 2,2-bis (4-cyanato-phenyl)-hexafluoropropane, biphenyl-4,4′-dicyanate;

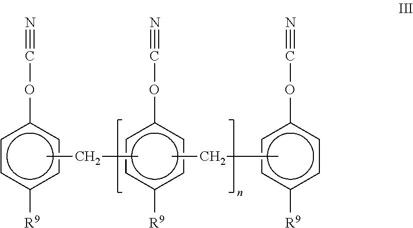

wherein R⁹ is hydrogen or C₁-C₁₀ alkyl, and n is an integer of 0 to 20, and

di-or multi-functional aliphatic cyanates having at least one fluorine in the aliphatic residue, and preferably of the structural formula IV:

N≡C—O—R¹⁰—O—C≡N IV

wherein R¹⁰ is a divalent organic non-aromatic hydrocarbon having at least one fluorine atom, and in particular with 3 to 12 carbon atoms, wherein the hydrogen atoms may be wholly or partially replaced by further fluorine atoms.

The invention uses the following favorable polysilazanes:

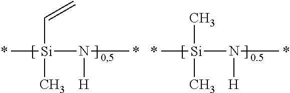

Silazane comprised of 50 mol percent dichlorvinylmethylsilan and 50 mol percent dichlorodimethylsilane, also known as VML50 in the context of the disclosure.

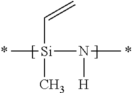

Vinyl-methyl-polysilazane, also known as VL100 in the context of the disclosure.

Said cyanates may be employed as monomers or as prepolymers, alone or admixed with each other or in a mixture with other monofunctional or polyfunctional cyanates.

The invention uses the following favorable cyanates:

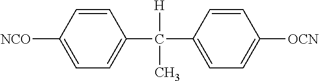

4,4′-methylmethylene-diphenyldicyanate, also known as L10 in the context of this disclosure.

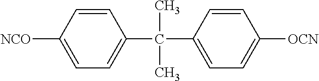

4,4′-dimethylmethylene-diphenyldicyanate, also known as B10 in the context of this disclosure.

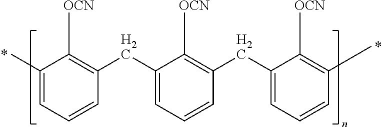

Oligo (3-methylene-1,5-phenylcyanate), also known as PT15 in the context of this disclosure.

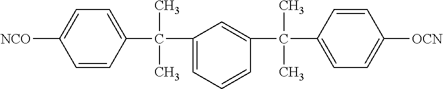

1,3-bis(4-cyanatophenyl-1-(1-methylethylidene)benzene, also known as XU366 in the context of the disclosure.

Examples of suitable cyanates to be mentioned are the dicyanate of bisphenol A (4,4′-dimethylmethylene-diphenyldicyanate), 4,4′ ethylidenediphenyldicyanate or compounds of the structural formula Ill, wherein n is 1, 2 or 3, R⁹ is hydrogen and the methylene group is in ortho position relative to the cyanate group.

he cyanate resin of the invention may further contain at least one filler. The material or composition of said filler is not critical. In this regard, reference is made to conventional fillers such as microfillers used as reinforcement materials in duromers, i.e., fillers with a particle size distribution primarily in the micrometer range. But nanofillers with smaller particle sizes (particle size distribution with a size concentration below the micrometer range) can also be used. Independently of the use of microfillers and/or nanofillers, these fillers are preferably selected from inorganic fillers that are optionally organically modified and/or coated. In as much as the fillers contain organo-phosphorous components, these components improve safety in fire situations. Suitable filler materials are, for example, silicon dioxide, ceramic materials, organically modified silicones or siloxanes or mixtures thereof, in particular those with very high surface areas and/or small particle sizes.

Said at least one fillers can be used alone or in mixtures. It was found that mixtures of different fillers of different materials are especially well suited. Their proportion within the resin can preferably be up to 20 percent by weight.

Optionally, other additives can be added to the starting material for the resins, or such additives can be subsequently admixed to the pre-polymerized resin. Examples of such additives are surface-modifying agents, for example agents that reduce the surface tension, e.g., fluorocarbon-modified polymers.

The cyanate resin according to the invention is suitable for all types of moldings, especially for the manufacture of prepregs and for infusion and pultrusion procedures. Thereby, a substrate (in particular a textile substrate) can be coated with or, in particular immersed with the cyanate resin. This can be accomplished, for example, by molding in a die, through which the solution-wetted substrate is drawn. Alternatively or additionally, the coated substrate is dried by heating preferably in a range between 80 to 130° C., i.e., the resin is prepolymerized. The duration of drying and thus the degree of prepolymerization are in a range between 1 to 10 minutes, depending on the selected temperature (and concrete composition of the resin), however the desired prepolymerization must be reached before the so-called gel point is reached so that renewed melting and later shaping is thus enabled. For the final processing (shaping under heat and potentially pressure), a temperature of 160° C., for example, can be employed.

In all variations of the invention, the cyanate resin can most favorably be prepared to contain at least one cyanate in admixture with at least one silazane or at least one silazane-containing compound. Said cyanate resins are disclosed in the relevant German disclosure DE 10 2009 013 410 A1 that can serve as reference to those skilled in the art.

The viscosity of the cyanate resin prior to curing is preferably 100 mPas or less, both in the presence or absence of silazane used as curing agent.

The invention further relates to a duromer, in particular to a cured duromer that is produced by compressing and/or heating of the aforementioned cyanate resin.

The following can be summarized in relation to the invention: Compared to various other duromers (cured duromers) with comparable crosslinking density and high glass transition temperature, cyanate resins in the cured state are less brittle, however, they require, like all other resins, improved fracture resistance for various applications, in particular for applications requiring high fracture tolerance. Particulate tougheners (i.e., impact modifiers) are generally distinguished from tougheners that cause phase separation during the curing process. The latter include classic rubber materials (such as CTBN) as well as thermoplastic materials. Tougheners used to date significantly increase viscosities and addition of comparatively large amounts of toughener is required. Therefore, these materials cannot be used for infusion applications. The aforementioned tougheners also drastically reduce the e-modulus, which must be considered in component design to compensate for the loss of the modulus. In addition, a decrease of the glass transition temperature is generally observed.

The present invention considers said characteristics of conventional tougheners. The invention relates to siloxane-tougheners, which are highlighted in particular because only small amounts are required, while increases of viscosity are extraordinarily small even with larger amounts of additive. In addition, no or only a very minimal reduction of the e-modulus and/or glass transition temperature is observed. The absorption of water is also reduced by the toughener.

The following figures illustrate preferred embodiments of the invention, wherein

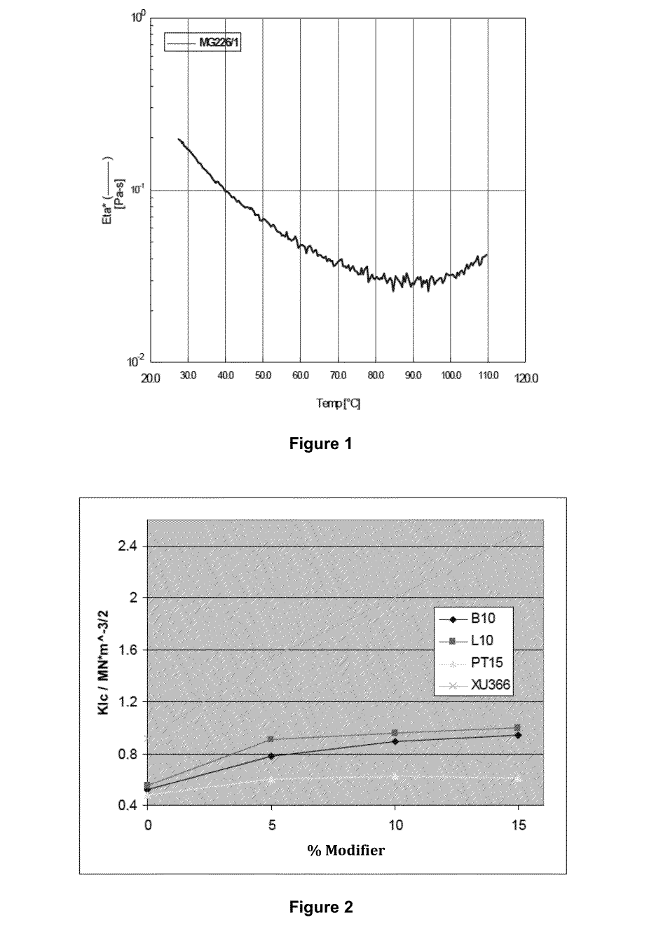

FIG. 1 shows the viscosity of the cyanate resin of the invention as a function of temperature while heating;

FIG. 2 shows the compression module and/or critical stress intensity factor Klc (also known as K1c) of the cyanate resin of the invention in mode 1 (i.e., with tensile stress) as a function of the weight percentage of a siloxane modifier;

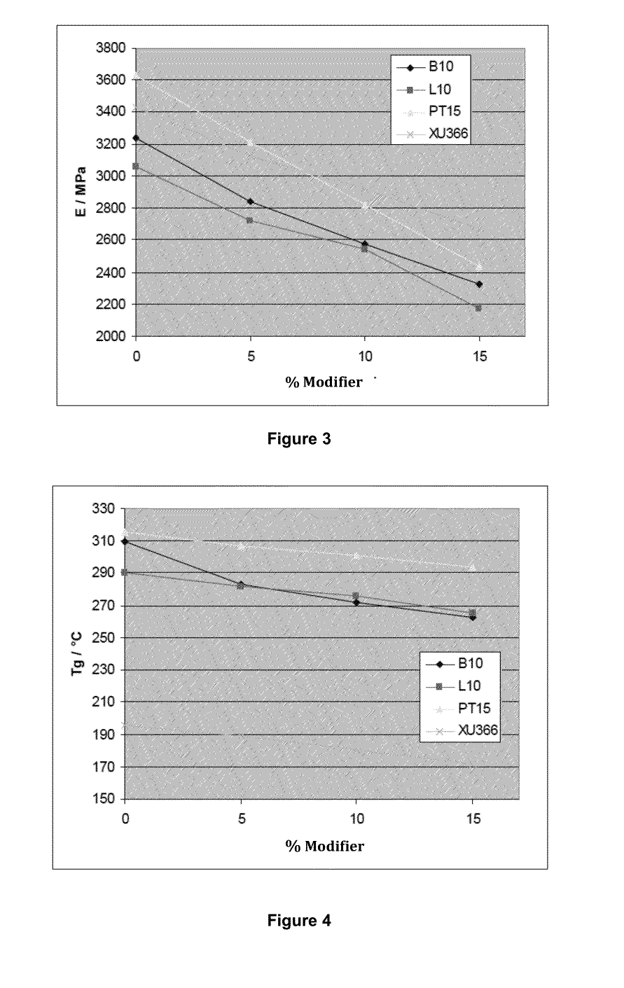

FIG. 3 shows the elastic modulus of the cyanate resin of the present invention as a function of the percentage by weight of the siloxane modifier;

FIG. 4 shows the glass transition temperature of the cyanate resin of the present invention as a function of percentage by weight of a siloxane modifier;

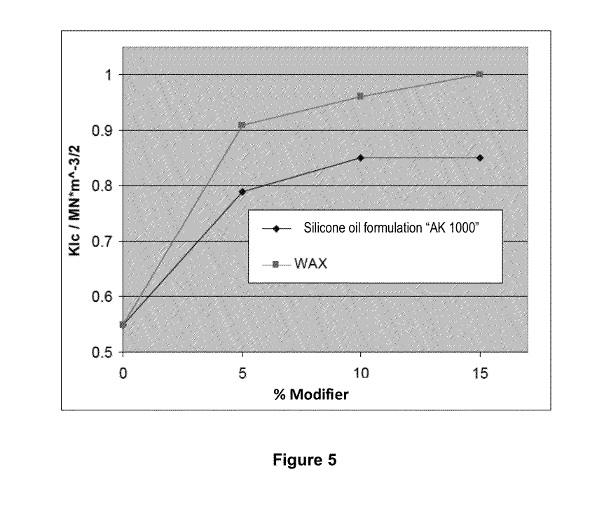

FIG. 5 shows the compression modulus and/or the critical stress intensity factor Klc (also known as K1c) of a cyanate resin admixed with a silicone oil formulation and/or wax in mode 1 (i.e., with tensile stress) of the present invention as a function of percentage by weight of the siloxane used as modifier. The silicone oil is a polydimethylsiloxane having a molecular weight between 900 to 1100. The wax (“Wax”) is a polydialkylsiloxane-caprolactone block copolymer of the structure A-B-A without reactive terminal groups.

The following examples explain the invention in more detail. The term WAX used therein represents a polydialkylsiloxane-caprolactone block copolymer of the structure A-B-A without reactive terminal groups.

Table 1 shows results of the test series MG226/1, H1 and MG226/2, H2 and MG225/2, H2, which were each conducted with a cyanate resin comprised of molecules L10 and VL100 admixed with the aforementioned wax siloxane with a percentage WAX by weight of 5 to the total weight of the cyanate resin. The percentage weight ratios, Ma %, of L10 to VL100 was 86/14, which combined accounted for 95 percent of the total cyanate resin weight. As reference series served the measurement MG225/2, H2, which was also conducted with a cyanate resin comprised of L10 and V100 with a percentage weight ratio Ma % of 86/14 without admixture of wax. Standard measurement procedures were conducted for determining the critical stress intensity factor K1c (also known as Klc) and the glass transition temperature and/or glass temperature, Tg; for example viscosity was measured using the dielectric constant of the cyanate resin as a function of temperature. K1c characterizes the fracture toughness of the cyanate resin. The test series in Table 1 show unequivocally that admixture of wax at a constant glass temperature results in substantial increase of K1c.

TABLE 1
L10 + VML50 and/or VL100 in a ratio of 8:2-Material properties

| | Ma % | WAX [%] | K1c [MN/m^{3/2}] | Tg [° C.] |
|---|---|---|---|---|
| L10/VL100 | 95(86/14) | 5 | 1.0 | 200 |
| MG226/1, H1 | | | | |
| L10/VL100 | 95(86/14) | 5 | 1.13 | 200 |
| MG226/2, H2 | | | | |
| L10/VL100 | 86/14 | 0 | 0.67 | 200 |
| MG225/2, H2 | | | | |

Table 2 shows a test series MG208/2, H4 with the cyanate resin in a composition comprised of equal parts of PT15 and L10, which combined contribute to 87 percent of the total weight of the cyanate resin, and VML50 contributing to 13 percent weight without admixture of wax. The test series MG215/2, H4 was conducted with cyanate resin in a composition comprised of equal parts of PT15 and L10, which combined contributed to 87 percent of the total weight of 95 percent of the cyanate resin, and VML50 contributing to 13 percent to the total weight of 95 percent of the cyanate resin, with the addition of wax contributing a weight proportion of WAX=5 percent to the total weight of the cyanate resin. The test series MG270/2a, H4 was conducted with a cyanate resin in a composition comprising equal parts of PT15 and L10, with a combined weight contributing to 86 percent of the total cyanate resin weight and VML50 contributing to 14 percent of the total weight of the cyanate resin without addition of wax. The test series MG241, H4 was conducted with the cyanate in a composition comprised of equal parts of PT15 and L10, with a combined weight contributing to 86 percent of the total weight of 95 percent of the cyanate resin, and VML50 contributing to 14 percent weight to the 95 percent of the total weight of the cyanate resin with the addition of wax, contributing by weight, WAX=5 percent to the total weight of the cyanate resin.

These results show that addition of wax increases K1c and only slightly modifies the glass transition temperature (i.e., essentially the same glass transition temperature) as a function of wax addition and that the resulting change of K1c is also a function of the polysilazane concentration.

TABLE 2
PT15/L10 + VML50 and/or VL100 in a ratio of 8:2-Material properties

| | Ma % | WAX [%] | K1c[MN/m^{3/2}] | Tg [° C.] |
|---|---|---|---|---|
| PT15/L10(1:1)/VML50 | 87/13 | 0 | 0.48 | 213 |
| MG208/2, H4 | | | | |
| PT15/L10(1:1)/VML50 | 87/13 | 5 | 0.89 | 216 |
| MG215/2, H4 | | | | |
| PT15/L10(1:1)/VL100 | 86/14 | 0 | 0.56 | 224 |
| MG270/2a, H4 | | | | |
| PT15/L10(1:1)/VL100 | 86/14 | 5 | 0.89 | 216 |
| MG241, H4 | | | | |

The aforementioned experiments were repeated with the difference being omission the silazane component. The results were comparable.

FIG. 1 shows for the test series MG226/1 that the viscosity eta* of the cyanate resin is a (global) minimum of approx. 27 mPas at approx. 90° C.

FIG. 2 shows results of the measurement series with a cyanate resin comprised of B10, L10 and PT15 and XU366 cyanates, demonstrating increase of Klc with increasing proportion and/or weight fraction of siloxane as modifier in all test series.

FIG. 3 supports the results from the test series shown in FIG. 2, demonstrating decrease of the elastic modulus E of the cyanate resin with increasing proportion of the siloxane as modifier.

FIG. 4 shows decreasing glass transition temperature Tg of the cyanate resin as a function of increasing proportion of the siloxane as modifier.

FIG. 5 shows an experimental series with a silicone oil formulation AK1000, having a viscosity of 1000 mPas as modifier compared to a series of tests conducted with WAX using polydimethylsiloxane-caprolactone copolymer as modifier. In both test series, an increase of Klc of the cyanate resin as a function of increasing percentage of modifier is shown, wherein the Klc increase is larger in the test series “WAX” than in the test series using a silicone oil formulation.

1. Cyanate resin, obtainable by combination of at least
(i) one difunctional, oligofunctional and/or polyfunctional cyanate and/or of at least one prepolymer thereof, optionally in combination with at least one additional copolymerizable component and
(ii) at least one siloxane and/or a siloxane-containing compound, wherein the resin contains a linear polydialkylsiloxane without reactive terminal groups and with a viscosity in a range between 500 to 1500 mPas and/or a polydialkylsiloxane-caprolactone copolymer or polydialkylsiloxane-caprolactam copolymer as siloxane and/or siloxane-containing compounds.

2. (canceled)

3. Cyanate according to claim 1, wherein said polydialkylsiloxane-caprolactone copolymer or polydialkylsiloxane-caprolactam copolymer is a polydialkylsiloxane-caprolactone copolymer.

4. Cyanate resin according to claim 1, wherein said polydialkylsiloxane-caprolactone copolymer or polydialkylsiloxane-caprolactam copolymer is a block copolymer of the formula ABA, wherein B is a polydialkylsiloxane unit.

5. Cyanate resin according to claim 1, wherein said polydialkylsiloxane-caprolactone copolymer or polydialkylsiloxane-caprolactam copolymer is a polydimethylsiloxane-caprolactone copolymer or a polydimethylsiloxane-caprolactam copolymer.

6. Cyanate resin according to claim 1, wherein said polydialkylsiloxane-caprolactone copolymer or polydialkylsiloxane-caprolactam copolymer is contained in a percent weight ratio of 2 to 10 percent weight preferably in a ratio of 3.5 to 6.5 percent weight based on the total of cyanate and siloxane and/or siloxane-containing compounds.

7. Cyanate resin according to claim 1, wherein the at least one additional copolymerizable component is or contains a monomeric, oligomeric, or polymeric silazane.

8. Cyanate resin according to claim 5, wherein said polydimethylsiloxane-caprolactone copolymer is a wax.

9. Cyanate resin according to claim 1, wherein the viscosity of said cyanate resin prior to curing is 100 mPas or less, or can be brought to this value.

10. Cyanate resin according to claim 1, wherein the proportion of siloxane and/or siloxane-containing compound is 0.5 to 50 percent weight based on the total weight of said cyanate resin.

11. Cyanate resin according to claim 1, wherein the viscosity of the siloxane and/or siloxane-containing compound is within a range between 100 to 10,000 mPas.

12. Substrate impregnated or coated with a cyanate resin according to claim 1.

13. Duromer obtainable by compressing and/or heating a cyanate resin according to claim 1.

14. Use of a cyanate resin according to claim 1 for the production of prepregs or for applications employed for infusion or pultrusion.

15. Duromer obtainable by compressing and/or heating a saturated or coated substrate according to claim 12.

16. Substrate according to claim 12, wherein the substrate is a textile substrate.

17. Duromer according to claim 13, wherein the duromer is a cured duromer.

18. Duromer according to claim 15, wherein the duromer is a cured duromer.
